(19) United States
(12) Patent Application Publication
(10) Pub. No.: US 2019/0108507 A1
(43) Pub. Date: Apr. 11, 2019

(54) SYSTEM AND METHOD OF DIGITIZING PHYSICAL CURRENCY OF A CASH TRANSACTION BETWEEN A MERCHANT AND A CUSTOMER

(71) Applicant: Cents Technologies Inc., Lawrence, NY (US)

(72) Inventor: Eliezer COHEN, Lawrence, NY (US)

(73) Assignee: Cents Technologies Inc., Lawrence, NY (US)

(21) Appl. No.: 15/999,275

(22) PCT Filed: Feb. 17, 2017
(86) PCT No.: PCT/US2017/018426

§ 371 Date: Aug. 17, 2018

Related U.S. Application Data
(60) Provisional application No. 62/296,419, filed on Feb. 17, 2016.

(51) Int. Cl. G06Q 20/32; G06Q 20/20; G06Q 20/06; G06Q 20/02

(52) U.S. Cl. CPC G06Q 20/3276; G06Q 20/209; G06Q 20/023; G06Q 20/065; G06Q 20/204

(57) ABSTRACT

Systems and methods for digitizing physical currency of a cash transaction between a merchant and a customer receive transaction data from a merchant POS device including an indication of an amount of change owed to a customer and an adjustment instruction authorizing an equivalent amount to be escrowed in a digital escrow account; send an escrow instruction enabling a transfer of the adjustment amount from a merchant account to the digital escrow account; generate an graphical symbol encoded with the adjustment instruction; send the encoded graphical symbol to the POS device for the POS device to print on a customer receipt; receive from a customer device, the adjustment instruction, wherein the graphical symbol was captured by the customer device and the adjustment instruction was decoded therefrom; and send a transfer instruction enabling transfer of the adjustment amount from the digital escrow account to a customer account.

### FIELD OF THE INVENTION

The present invention is in the field of transaction technology. In particular, the present invention is directed to systems and methods for digitizing physical currency of a cash transaction between a merchant and a customer.

### BACKGROUND OF THE INVENTION

Coins are a significant part of any physical currency system. For example, Unites States currency includes various denominations of coins which, along with bills, can be used to pay for products and services in a cash transaction, e.g., between a customer and a merchant. Coins are also often used when a particular amount of change is to be returned to a customer in a cash transaction, e.g., when a customer tenders one or more bills which add up to the nearest whole dollar (or nearest convenient or available bill denomination) above a sale price. In such instances, particularly when the sale price is not a whole dollar amount, the merchant will typically return the balance or change in some combination of dollars and coins.

However, coins can be hard to manage, are often lost or discarded, and cost the government millions of dollars to produce. An estimated $62 million in coins is lost by Americans each year. The Transportation Security Administration alone collected $675,000 in spare change left by travelers in 2014. While many consumers and merchants regularly transact using credit cards, debit cards, digital wallets and other forms of digital currency, over 85% of all transactions in the U.S. still involve cash, including coins. Although paying in cash can have its benefits, dealing with change in general, and coins in particular, can be inconvenient and time consuming. Furthermore, it can be difficult to track cash transactions: paper or email receipts can get lost, make checkout longer, and are also hard to manage and keep track of, making returns and budgeting harder. Additionally, typical customer loyalty programs may have limited compatibility with physical currency (e.g., cash) transactions.

### SUMMARY OF THE INVENTION

An embodiment of the invention includes a method for digitizing physical currency of a cash transaction between a merchant and a customer. Some embodiments may be performed on a server, for example, having a processor, memory and one or more code sets stored in the memory and executed by the processor. In some embodiments, the method may include receiving transaction data from a Point of Sale (POS) device of the merchant including at least: an indication of an amount of change owed to a customer based on a sale price and an amount of cash tendered by the customer to the merchant; and an adjustment instruction, in which the adjustment instruction authorizes an adjustment amount equivalent to the amount of change owed to be escrowed in a digital escrow account; sending an escrow instruction enabling a transfer of the adjustment amount from an account of the merchant to the digital escrow account; generating a graphical symbol encoded with data that may be associated with the adjustment instruction; sending the graphical symbol to the POS device, in which the POS device may be configured to print the graphical symbol on a customer receipt; receiving from a customer device, the data associated with the adjustment instruction, in which the graphical symbol was captured by the customer device and the data associated with the adjustment instruction was decoded from the captured graphical symbol by the customer device; and sending a transfer instruction, in which the transfer instruction enables transfer of the adjustment amount from the digital escrow account to a customer account associated with the customer.

In some embodiments, the graphical symbol may be a Quick Response (QR) Code. In some embodiments, the graphical symbol may be at least one of a bar code, a multi-dimensional graphical symbol, and a holographic symbol. In some embodiments, the merchant account may be one of a bank account, an Automated Clearing House account, and credit card account.

In some embodiments, the method may further include rejecting the adjustment instruction when the merchant account does not contain sufficient funds to be transferred to the digital escrow account. In some embodiments, the digital escrow account may be an account inaccessible to the merchant and in which funds may deposited by the merchant account and held there in escrow until such time as they are transferred to an authorized account.

In some embodiments, the adjustment instruction may be based on at least one of a verbal confirmation from the customer, a predetermined indication and a confirmation from the POS device.

In some embodiments, the method may further include updating account information associated with the customer account. In some embodiments, the method may further include sending a confirmation to a contact of the customer.

Another embodiment of the method for digitizing physical currency of a cash transaction between a merchant and a customer may include receiving transaction data from a Point of Sale (POS) device of the merchant including at least: an indication of an amount of change owed to a customer based on a sale price and an amount of cash tendered by the customer to the merchant; and a transfer instruction which authorizes an amount equivalent to the amount of change owed to be transferred to a customer account; generating a graphical symbol encoded with data that may be associated with the transfer instruction; sending the graphical symbol to the POS device, in which the POS device may be configured to print the graphical symbol on a customer receipt; receiving from a customer device the data associated with the transfer instruction, in which the graphical symbol was captured by the customer device and the data associated with the transfer instruction was decoded from the captured graphical symbol by the customer device; and transferring the amount equivalent to the amount of change owed to the customer account associated with the customer.

In accordance with further embodiments of the invention, one or more systems may be provided which may implement one or more of the methods described herein according to embodiments of the invention.

These and other aspects, features and advantages will be understood with reference to the following description of certain embodiments of the invention.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features and advantages thereof, may best be understood by reference to the following detailed description when read with the accompanied drawings. Some embodiments of the invention are illustrated by way of example and not limitation in the figures of the accompanying drawings, in which like reference numerals indicate corresponding, analogous or similar elements, and in which:

FIG. 1 is a high level diagram illustrating an example configuration of a system for digitizing physical currency of a cash transaction between a merchant and a customer, according to at least one embodiment of the invention; and

FIG. 2 is a flow diagram of an example method for digitizing physical currency of a cash transaction between a merchant and a customer, according to at least one embodiment of the invention.

It will be appreciated that, for simplicity and clarity of illustration, elements shown in the figures have not necessarily been drawn accurately or to scale. For example, the dimensions of some of the elements may be exaggerated relative to other elements for clarity, or several physical components may be included in one functional block or element. Further, where considered appropriate, reference numerals may be repeated among the figures to indicate corresponding or analogous elements.

### DETAILED DESCRIPTION OF THE INVENTION

In the following description, various aspects of the present invention will be described. For purposes of explanation, specific configurations and details are set forth in order to provide a thorough understanding of the present invention. However, it will also be apparent to one skilled in the art that the present invention may be practiced without the specific details presented herein. Furthermore, well known features may be omitted or simplified in order not to obscure the present invention.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory processor-readable storage medium that may store instructions, which when executed by the processor, cause the processor to perform operations and/or processes. Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. The term set when used herein may include one or more items. Unless explicitly stated, the method embodiments described herein are not constrained to a particular order or sequence. Additionally, some of the described method embodiments or elements thereof may occur or be performed simultaneously, at the same point in time, or concurrently.

Some embodiments of the invention offer a software-based solution that addresses the problems discussed above, including the loss of loose coin change, management of coins and cash payments, and lack of integration with loyalty programs. Furthermore, some embodiments of the invention solve the problem of lost receipts, and assist stores in tracking cash purchases, e.g., in addition to online and credit purchases. Some embodiments of the invention further enable innovative target marketing to help stores maintain customer loyalty, and help customers find what they are looking for, which minimizing queue and checkout time for customers and merchants.

Some embodiments of the inventions include an encoded graphical symbol system, such as Quick Response (QR) code system or bar code system, which may require less merchant/consumer interaction at checkout, as described herein. In some embodiments, when a customer makes a cash purchase at a merchant store and tenders cash requiring change to be returned by the merchant to the customer, loose coin change that would usually be returned to the customer as change may instead be digitally printed onto a receipt by the Point of Sale (POS) device of the merchant, e.g., in the form of a QR code generated, e.g., by an back-end server and provided, e.g., via an Application Programming Interface (API) module to the POS device.

Subsequently, the customer may scan this QR code, e.g., via a mobile application installed on the customer's mobile device, causing the equivalent sum of money to be transferred to an account associated with the customer. In some embodiments, a copy of the receipt, and/or any loyalty/coupon/rewards information relating to the merchant may also or alternatively be added to the customer's account. In some embodiments, loyalty points, coupons, and/or rewards can be redeemed, e.g., for free gifts and store coupons. In some embodiments, the QR code scanner installed on the customer's mobile device may also double as a bar-code scanner to check item prices, reviews, and potential sales and coupons. To use money in collected funds, in some embodiments, the customer may simply pay, e.g., via a Near Field Communication (NFC) feature or a bar code representing a virtual card. Some embodiments enable customers to manage receipts, loose coin change, and rewards all organized in one account for ease of use, peace of mind, and easy management.

In some embodiments, once a purchase is made at a participating merchant store having a POS system integrated with the system API, the merchant POS may be configured to print out the customer's receipt with a QR code thereon. In some embodiments, depending on the method of payment and/or the direction of the customer and/or the merchant, the QR code may be associated with an amount of change, e.g., one to ninety-nine cents in coins (or more) and/or a digital copy of your receipt and/or Loyalty information. The customer is then able to scan the QR code via the mobile application, at a later point, thus eliminating the time associated with counting and returning change from the checkout process. Instead, once scanned, the items represented by (or otherwise associated with) the QR code will make their way into their respected areas on customer's application. In some embodiments, similar information regarding the transaction can be aggregated in a merchant portal, giving merchants a better sense where customers shop, what they purchase, etc. In some embodiments, if the customer declines to can a receipt QR code, e.g., within a predetermined period of time, the amount of change associated with the QR code may be transferred to a third party, e.g., a charity of the customer's or merchant's choosing.

In some embodiments, all that is required for integration and implementation of the invention is for a merchant store to be enabled with these abilities by integrating the system with its POS systems to print the QR code that will be scanned by the customer, and for the customer to install the application on his or her mobile device. In some embodiments, the QR code may be provided to the customer and the merchant may provide a QR scanner which may be used by the customer to scan the QR code. In either case, the customer may create or be provided with a customer account. Once an account is created, in some embodiments, during the transaction the customer simply alerts the merchant that any change should be directed to the customer account via the QR code, and then, after the purchase has been completed, the customer may scan the generated QR code which has been printed on the receipt. These and other features are described in further detail herein.

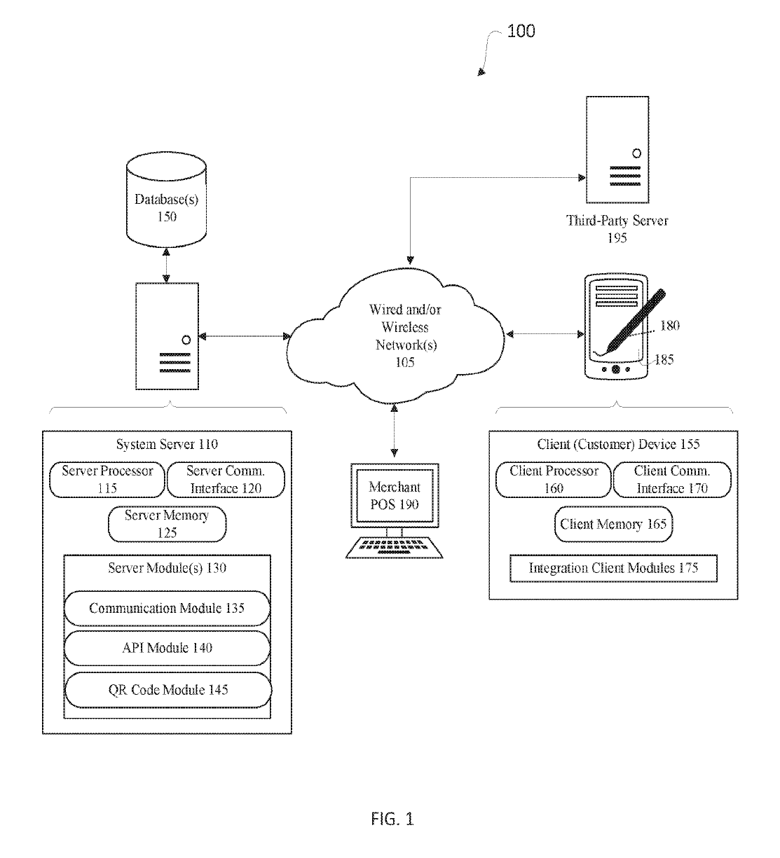

FIG. 1 shows a high level diagram illustrating an example configuration of a system 100 for digitizing physical currency of a cash transaction between a merchant and a customer, according to at least one embodiment of the invention. System 100 includes network 105, which may include the Internet, one or more telephony networks, one or more network segments including local area networks (LAN) and wide area networks (WAN), one or more wireless networks, or a combination thereof. System 100 also includes a system server 110 constructed in accordance with one or more embodiments of the invention. In some embodiments, system server 110 may be a stand-alone computer system. In other embodiments, system server 110 may include a network of operatively connected computing devices, which communicate over network 105. Therefore, system server 110 may include multiple other processing machines such as computers, and more specifically, stationary devices, mobile devices, terminals, and/or computer servers (collectively, “computing devices”). Communication with these computing devices may be, for example, direct or indirect through further machines that are accessible to the network 105.

System server 110 may be any suitable computing device and/or data processing apparatus capable of communicating with computing devices, other remote devices or computing networks, receiving, transmitting and storing electronic information and processing requests as further described herein. System server 110 is, therefore, intended to represent various forms of digital computers, such as laptops, desktops, workstations, personal digital assistants, servers, blade servers, mainframes, and other appropriate computers and/or networked or cloud based computing systems capable of employing the systems and methods described herein.

System server 110 may include a server processor 115 which is operatively connected to various hardware and software components that serve to enable operation of the system 100. Server processor 115 serves to execute instructions to perform various operations relating to functions of some embodiments of the invention as described herein. Server processor 115 may be one or a number of processors, a central processing unit (CPU), a graphics processing unit (GPU), a multi-processor core, or any other type of processor, depending on the particular implementation. System server 110 may be configured to communicate via communication interface 120 with various other devices connected to network 105. For example, communication interface 120 may include but is not limited to, a modem, a Network Interface Card (NIC), an integrated network interface, a radio frequency transmitter/receiver (e.g., Bluetooth wireless connection, cellular, Near-Field Communication (NFC) protocol, a satellite communication transmitter/receiver, an infrared port, a USB connection, and/or any other such interfaces for connecting the system server 110 to other computing devices and/or communication networks such as private networks and the Internet.

In certain implementations, a server memory 125 is accessible by server processor 115, thereby enabling server processor 115 to receive and execute instructions such a code, stored in the memory and/or storage in the form of one or more software modules 130, each module representing one or more code sets. The software modules 130 may include one or more software programs or applications (collectively referred to as the “server application”) having computer program code or a set of instructions executed partially or entirely in server processor 115 for carrying out operations for aspects of the systems and methods disclosed herein, and may be written in any combination of one or more programming languages. Server processor 115 may be configured to carry out some embodiments of the present invention by, for example, executing code or software, and may be or may execute the functionality of the modules as described herein.

As shown in FIG. 1, the exemplary software modules may include a communication module 135, an API module 140, and a QR Code module 145. Communication module 135 may be executed by server processor 115 to facilitate communication between system server 110 and the various software and hardware components of system 100, such as, for example, server database 150, client device 155, and/or Merchant POS 190, as described herein. API module 140, as described in detail herein, may be executed by server processor 115 to implement the various functions of the API. Of course, in some embodiments, the API may reside on and/or be implemented by a remote or otherwise separate server entirely. And QR Code module 145 may be executed by server processor 115 to generate, provide, and/or otherwise manage QR Codes as described herein.

It should be noted that, in accordance with various embodiments of the invention, server modules 130 may be executed entirely on system server 110 as a stand-alone software package, partly on system server 110 and partly on client device 155, entirely on client device 155, partly on system server 110 and partly on Merchant POS 190, entirely on Merchant POS 190, or partly on Merchant POS 190 and partly on client device 155, depending on the particular system configuration.

Server memory 125 may be, for example, a random access memory (RAM) or any other suitable volatile or non-volatile computer readable storage medium. Server memory 125 may also include storage which may take various forms, depending on the particular implementation. For example, the storage may contain one or more components or devices such as a hard drive, a flash memory, a rewritable optical disk, a rewritable magnetic tape, or some combination of the above. In addition, the memory and/or storage may be fixed or removable. In addition, memory and/or storage may be local to the system server 110 or located remotely.

In accordance with further embodiments of the invention, system server 110 may be connected to one or more database(s) 150, for example, directly or remotely via network 105. Database 150 may include any of the memory configurations as described above, and may be in direct or indirect communication with system server 110. In some embodiments, database 150 stores the results/outputs of various modules, as described herein, and can represent a plurality of separate databases and/or partitions in a single database.

As described herein, among the computing devices on or connected to the network 105 may be one or more client (e.g., customer) devices 155. Client device 155 may be any standard computing device. As understood herein, in accordance with one or more embodiments, a computing device may be a stationary computing device, such as a desktop computer, kiosk and/or other machine, each of which generally has one or more processors, such as client processor 160, configured to execute code to implement a variety of functions, a computer-readable memory, such as client memory 165, a client communication interface 170, for connecting to the network 105, one or more client modules, such as integration client module 175, one or more input devices, such as input device 180, and one or more output devices, such as output device 185. Typical input devices, such as, for example, input device 185, may include a touch-sensitive display, pointing device (e.g., mouse or digitized stylus), a keyboard, and/or a camera or other sensor, etc. Typical output devices, such as, for example output device 185 may include one or more of a monitor, display, speaker, printer, etc.

In some embodiments, integration client module 175 may be executed by client processor 160 to provide the various functionalities of client device 155. In particular, in some embodiments, integration client module 175 may provide a client-side interface with which a user of client device 155 can interact, to, among other things, capture and send data relating to QR Codes, manage transactions, etc.

Additionally or alternatively, a computing device may be a mobile electronic device (“MED”), which is generally understood in the art as having hardware components as in the stationary device described above, and being capable of embodying the systems and/or methods described herein, but which may further include componentry such as wireless communications circuitry, gyroscopes, inertia detection circuits, geolocation circuitry, touch sensitivity, among other sensors. Non-limiting examples of typical MEDs are smartphones, personal digital assistants, tablet computers, and the like, which may communicate over cellular and/or Wi-Fi networks or using a Bluetooth or other communication protocol. Typical input devices associated with conventional MEDs include, keyboards, microphones, accelerometers, touch screens, light meters, digital cameras, and the input jacks that enable attachment of further devices, etc.

In some embodiments, client device 155 may be a “dummy” terminal, by which processing and computing may be performed on system server 110 (or Merchant POS 190) and information may then be provided to client device 155, e.g., via server communication interface120 for display and/or basic data manipulation. In some embodiments, modules depicted as existing on and/or executing on one device may additionally or alternatively exist on and/or execute on another device. For example, in some embodiments, API module 140, which is depicted in FIG. 1 as existing and executing on system server 110, may additionally or alternatively exist and/or execute on Merchant POS 190. In some embodiments, Merchant POS 190 may provide the same or similar structure and functionality as system server 110, but may be owned, possessed, and/or operated by a different entity from system server 110. Furthermore, in some embodiments, Merchant POS 190 may be any stand-alone or computer-implemented Point of Sale device or terminal used for processing payments as understood by those of ordinary skill in the arts. In some embodiments, system 100 may further include one or more third-party servers 195. In some embodiments, third-party server may provide the same or similar structure and functionality as system server 110, but may be owned, possessed, and/or operated by a different entity from system server 110. For example, third-party server 195 may be one or more of a third-party financial provider, third-party promotional provider, third-party transaction processor, etc.

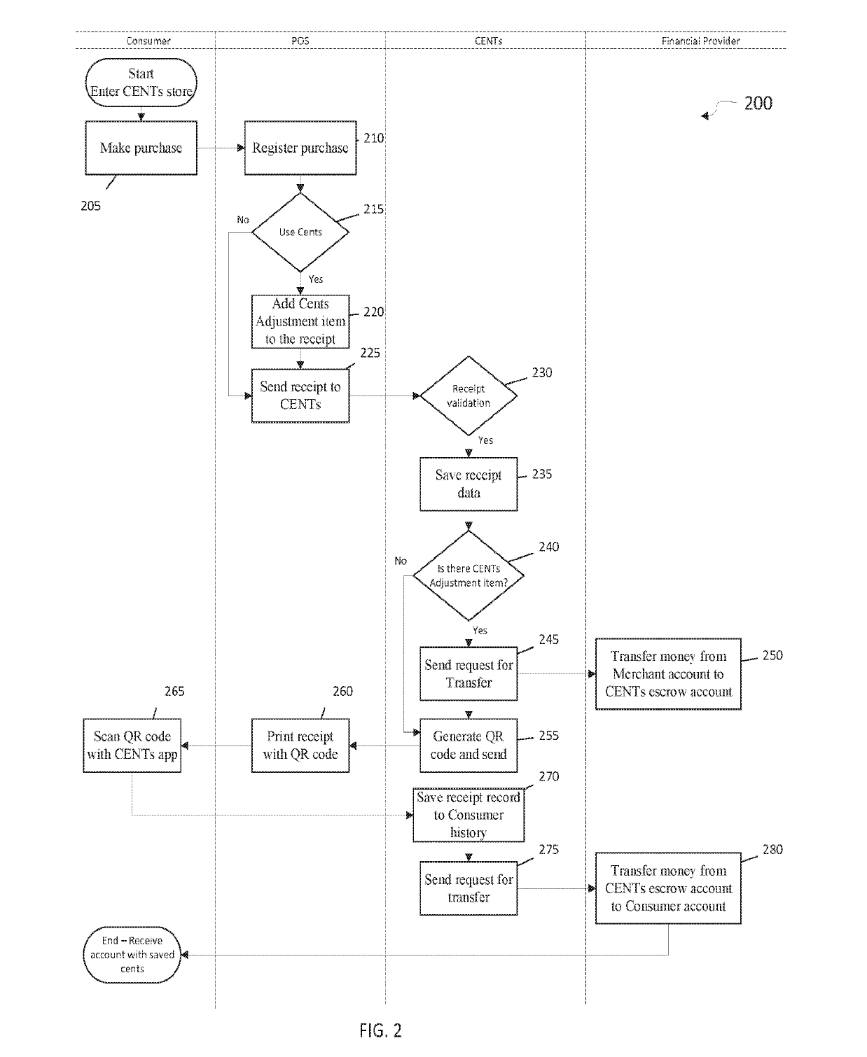

FIG. 2 is a flow diagram of a method for digitizing physical currency of a cash transaction between a merchant and a customer, according to at least one embodiment of the invention. In some embodiments, method 200 may be performed on a computer (e.g., system server 110) having a processor (e.g., server processor 115), memory (e.g., server memory 125), and one or more code sets (e.g., server module(s) 130) stored in the memory and executing in the processor. The method begins at step 205, when a customer make a purchase or otherwise executes a cash transaction, e.g., at a merchant store, using physical currency, e.g., cash. At step 210, in some embodiments, a POS device (e.g., Merchant POS 190) may be configured to register the purchase, including, for example, one or more of a sale price, an amount of cash tendered by the customer to the merchant, and an indication of an amount of change owed to the customer based on the sale price and the amount of cash tendered, a time stamp, etc.

At step 215, in some embodiments, the POS device may be configured to receive, process, and/or execute an adjustment instruction, e.g., from the customer. In some embodiments, the adjustment instruction may authorize an adjustment amount equivalent to the amount of change owed to the customer to be escrowed, e.g., in a digital escrow account. For example, in some embodiments, the adjustment instruction may be based on an explicit request from the customer, who may have been prompted to state a catch-phrase such as “I'd like to use ‘Cents’” (referring to a commercial platform, for example called “Cents Technologies”, which may be configured to execute embodiments of the invention), or may simply request to have the change amount transferred instead to an account associated with the customer. In some embodiments, if an adjustment instruction is received, then the method continues at step 220, and if no adjustment instruction is received, the method continues at step 225.

At step 220, in some embodiments, when an adjustment instruction is received, processed and/or executed, the POS device may be configured to add an adjustment item representative of the adjustment instruction to the receipt. At step 225, in some embodiments, the POS device may be configured to send the receipt (e.g., some or all of the transaction information related to the purchase, as well as the adjustment information if it has been added at step 220) to a system server for further processing as described herein.

At step 230, in some embodiments, processor of the system server may be configured to receive the transaction data (e.g., the receipt or a portion of the information contained therein) from the POS device of the merchant, which may include, for example, an indication of an amount of change owed to a customer based on a sale price and an amount of cash tendered by the customer to the merchant, and/or the adjustment instruction authorizing an adjustment amount equivalent to the amount of change owed to be escrowed in a digital escrow account. The processor may be further configured to validate the receipt and/or all or part of the transaction information contained therein.

At step 235, in some embodiments, the processor may be configured to save or otherwise store the receipt data and/or all or part of the transaction information contained therein.

At step 240, in some embodiments, the processor may be configured to identify whether or not an adjustment item was included in the receipt, e.g., whether and adjustment instruction was received from the POS device in the transaction data, and/or to identify the adjustment item itself.

At step 245, in some embodiments, when an adjustment item has been identified, e.g., an adjustment instruction has been received from the POS device, the processor may be configured to send an escrow instruction enabling a transfer of the adjustment amount from an account of the merchant to the digital escrow account. In some embodiments, the merchant account and/or the digital escrow account may reside at and/or be controlled by one or more third-party servers, e.g., of one or more financial providers, etc.

At step 250, in some embodiments, the third-party server (e.g., of a financial provider) may be configured to receive the escrow instruction from the processor, and may then execute a transfer of the adjustment amount from an account of the merchant to the digital escrow account. In some embodiments, the merchant account may be a dedicated bank account such as a debit account, an Automated Clearing House (ACH) account, or may be a credit card account, etc. In some embodiments, the merchant account may be required to contain sufficient liquid or available funds to be transferred to the digital escrow account; otherwise, in some embodiments, the adjustment instruction may be rejected. In some embodiments, the digital escrow account may be an account which may receive funds from the merchant account but which is inaccessible to the merchant, and in which funds may deposited and held in escrow until such time as they may be transferred to an authorized account, such as a customer account or an elected charity accounted, e.g., if the funds are not transferred to a customer account with a predefined timeframe.

At step 255, in some embodiments, the processor may be configured to generate a graphical symbol, e.g., generate data representing a graphical symbol, encoded with data that is associated with the adjustment instruction. In some embodiments, the graphical symbol may be a Quick Response (QR) Code, a bar code, a multi-dimensional graphical symbol, a holographic symbol, etc. In some embodiments, the encoding may include verification data, adjustment instructions, and/or other information related to the transaction. In some embodiments, once the graphical symbol has been generated, the processor may be configured to send the graphical symbol to the POS device to be printed, e.g., by the POS device, on a customer receipt for the customer. In some embodiments, the graphical symbol may instead be sent directly to the customer (e.g., to the mobile application on the customer's device, to an e-mail address, mobile device number, social media account, etc.).

At step 260, in some embodiments, the POS device may be configured to receive the graphical symbol and to print the graphical symbol on a customer receipt, for example, below the transaction information.

At step 265, in some embodiments, the customer device may be configured to capture the graphical symbol and decode the data associated with the adjustment instruction. In order to capture and decode the graphical symbol, the customer may be provided with a mobile application which activates a camera or other sensor to detect and capture the QR code (e.g., as a QR scanner) and decode the information encoded therein. In doing so, the customer may be instructed by the mobile application to point the camera or sensor at the QR code printed on the customer receipt such that the QR code may be scanned or otherwise captured by the mobile device. In other embodiments, the customer may simply take a digital picture of the QR code and provide it to the system server a third-party server processing on behalf of the customer. In some embodiments, the QR code may be displayed on a screen of the mobile device (e.g., after being captured or received directly from the system server processor) and scanned by the POS device which may then process the QR code on behalf of the customer. In some embodiments, the QR code itself and/or the decoded information may then be provided to the processor (e.g., sent by the customer mobile device, etc.).

At step 270, in some embodiments, the processor may receive, e.g., from the customer device, the data associated with the adjustment instruction, e.g., which had been captured and decoded, e.g., from the captured graphical symbol, for example, by the customer device. In some embodiments, the received data and information may be saved and or recorded to the customer account, e.g., to a customer history record of the customer account.

At step 275, in some embodiments, the processor may send a transfer instruction, for example, to the third-party server (e.g., the financial provider). In some embodiments, the transfer instruction may enable transfer of the adjustment amount from the digital escrow account to a customer account associated with the customer.

At step 280, in some embodiments, upon receiving the transfer instruction, the recipient of the instruction, e.g., the third-party server (e.g., the financial provider), may then execute the transfer of the adjustment amount from the digital escrow account to a customer account associated with the customer, making the funds available to the customer via the customer's account, and the method ends. In some embodiments, the processor may then update account information associated with the customer account and/or send a confirmation to a contact (e.g., e-mail, SMS, social media account) of the customer.

Unless explicitly stated, the method embodiments described herein are not constrained to a particular order or sequence. Furthermore, all formulas described herein are intended as examples only and other or different formulas may be used. Additionally, some of the described method embodiments or elements thereof may occur or be performed at the same point in time.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

Various embodiments have been presented. Each of these embodiments may of course include features from other embodiments presented, and embodiments not specifically described may include various features described herein.

1. A method for digitizing physical currency of a cash transaction between a merchant and a customer, performed on a server having a processor, memory, and one or more code sets stored in the memory and executed by the processor, the method comprising:
receiving, at the processor, transaction data from a Point of Sale (POS) device of the merchant including at least:
an indication of an amount of change owed to a customer based on a sale price and an amount of cash tendered by the customer to the merchant; and
an adjustment instruction, wherein the adjustment instruction authorizes an adjustment amount equivalent to the amount of change owed to be escrowed in a digital escrow account;
sending, by the processor, an escrow instruction enabling a transfer of the adjustment amount from an account of the merchant to the digital escrow account;
generating, by the processor, a graphical symbol encoded with data that is associated with the adjustment instruction;
sending, by the processor, the graphical symbol to the POS device, wherein the POS device is configured to print the graphical symbol on a customer receipt;
receiving, at the processor from a customer device, the data associated with the adjustment instruction, wherein the graphical symbol was captured by the customer device and the data associated with the adjustment instruction was decoded from the captured graphical symbol by the customer device; and
sending, by the processor, a transfer instruction, wherein the transfer instruction enables transfer of the adjustment amount from the digital escrow account to a customer account associated with the customer.

2. The method as in claim 1, wherein the graphical symbol is a Quick Response (QR) Code.

3. The method as in claim 1, wherein the graphical symbol is at least one of a bar code, a multi-dimensional graphical symbol, and a holographic symbol.

4. The method as in claim 1, wherein the merchant account is one of a bank account, an Automated Clearing House account, and credit card account.

5. The method as in claim 4, further comprising rejecting the adjustment instruction when the merchant account does not contain sufficient funds to be transferred to the digital escrow account.

6. The method as in claim 1, wherein the digital escrow account is an account inaccessible to the merchant and in which funds may deposited by the merchant account and held in escrow until such time as they are transferred an authorized account.

7. The method as in claim 1, wherein the adjustment instruction is based on at least one of a verbal confirmation from the customer, a predetermined indication, and, a confirmation from the POS device.

8. The method as in claim 1, further comprising updating, by the processor, account information associated with the customer account.

9. The method as in claim 1, further comprising sending, by the processor, a confirmation to a contact of the customer.

10. A system for digitizing physical currency of a cash transaction between a merchant and a customer, comprising:
a server having a processor and memory; and
one or more code sets stored in the memory and executed by the processor, which, when executed, configure the processor to:
receive transaction data from a Point of Sale (POS) device of the merchant including at least:
an indication of an amount of change owed to a customer based on a sale price and an amount of cash tendered by the customer to the merchant; and
an adjustment instruction, wherein the adjustment instruction authorizes an adjustment amount equivalent to the amount of change owed to be escrowed in a digital escrow account;
send an escrow instruction enabling a transfer of the adjustment amount from an account of the merchant to the digital escrow account;
generate a graphical symbol encoded with data that is associated with the adjustment instruction;
send the graphical symbol to the POS device, wherein the POS device is configured to print the graphical symbol on a customer receipt;
receive from a customer device the data associated with the adjustment instruction, wherein the graphical symbol was captured by the customer device and the data associated with the adjustment instruction was decoded from the captured graphical symbol by the customer device; and
send a transfer instruction, wherein the transfer instruction enables transfer of the adjustment amount from the digital escrow account to a customer account associated with the customer.

11. The system as in claim 10, wherein the graphical symbol is a Quick Response (QR) Code.

12. The system as in claim 10, wherein the graphical symbol is at least one of a bar code, a multi-dimensional graphical symbol, and a holographic symbol.

13. The system as in claim 10, wherein the merchant account is one of a bank account, an Automated Clearing House account, and credit card account.

14. The system as in claim 13, wherein the processor is further configured to reject the adjustment instruction when the merchant account does not contain sufficient funds to be transferred to the digital escrow account.

15. The system as in claim 10, wherein the digital escrow account is an account inaccessible to the merchant and in which funds may deposited by the merchant account and held in escrow until such time as they are transferred an authorized account.

16. The system as in claim 10, wherein the adjustment instruction is based on at least one of a verbal confirmation from the customer, a predetermined indication, and, a confirmation from the POS device.

17. The system as in claim 10, wherein the processor is further configured to update account information associated with the customer account.

18. The system as in claim 10, wherein the processor is further configured to send a confirmation to a contact of the customer.

19. A method for digitizing physical currency of a cash transaction between a merchant and a customer, performed on a server having a processor, memory, and one or more code sets stored in the memory and executed by the processor, the method comprising:
receiving, at the processor, transaction data from a Point of Sale (POS) device of the merchant including at least:
an indication of an amount of change owed to a customer based on a sale price and an amount of cash tendered by the customer to the merchant; and
a transfer instruction which authorizes an amount equivalent to the amount of change owed to be transferred to a customer account;
generating, by the processor, a graphical symbol encoded with data that is associated with the transfer instruction;
sending, by the processor, the graphical symbol to the POS device, wherein the POS device is configured to print the graphical symbol on a customer receipt;
receiving, at the processor from a customer device, the data associated with the transfer instruction, wherein the graphical symbol was captured by the customer device and the data associated with the transfer instruction was decoded from the captured graphical symbol by the customer device; and
transferring, by the processor, the amount equivalent to the amount of change owed to the customer account associated with the customer.

20. The method as in claim 19, wherein the graphical symbol is a Quick Response (QR) Code.
